(19) United States
(12) Patent Application Publication
(10) Pub. No.: US 2024/0072318 A1
(43) Pub. Date: Feb. 29, 2024

(54) BATTERY PRECONDITIONING UNDER ELEVATED TEMPERATURES

(71) Applicant: Ford Global Technologies, LLC, Dearborn, MI (US)

(72) Inventors: Minghong LIU, Northville, MI (US); Alvaro MASIAS, Ann Arbor, MI (US)

(73) Assignee: Ford Global Technologies, LLC, Dearborn, MI (US)

(21) Appl. No.: 17/894,446

(22) Filed: Aug. 24, 2022

(51) Int. Cl. H01M 10/44; B60L 58/16; B60L 58/27; H01M 10/625

(52) U.S. Cl. CPC H01M 10/446; B60L 58/16; B60L 58/27; H01M 10/625; H01M 2220/20

(57) ABSTRACT

A lithium-ion battery cell is preconditioned using an initial, one-time process of cell formation at an elevated temperature, or after cell formation, charge/discharge cycling for a predetermined number of cycles within a specified period of time at an elevated temperature prior to being placed in service. The process may be performed as part of manufacturing during cell formation after electrolyte filling and pre-charging. Alternatively, the pre-conditioning process may be performed after assembly of finished cells within a multi-cell battery, either before or after installation of the battery in a product, but before the battery is subjected to harsh conditions, such as fast charging and/or discharging at low temperature. An electrified vehicle may include an electric machine powered by a multi-cell lithium-ion battery preconditioned according to the initial, one-time process.

### TECHNICAL FIELD

This disclosure generally relates to battery preconditioning and an electrified vehicle having a preconditioned traction battery.

### BACKGROUND

Electrified vehicles and various other applications may include a battery that includes a number of electrically connected cells to provide a desired overall battery voltage, current, and energy storage capacity. Various sizes, configurations, and capacities of lithium-ion batteries (LIBs) power many devices of modern life other than electrified vehicles including mobile phones, computers, power tools, electronics, etc. As batteries with higher energy density and capacity become available, users continue to expect long cycle life in addition to faster charging under a wide range of environmental conditions commensurate with the wide range of devices and applications. However, use scenarios including low temperature and high charge/discharge rates, for example, present various challenges for battery manufacturers and OEMs in meeting such user expectations.

### SUMMARY

According to one or more aspects of the present disclosure, initial, one-time preconditioning of battery cells prior to being placed in normal service operation by cell formation at an elevated temperature or by charge/discharge cycling at elevated temperature for a limited number of cycles during a limited time period may provide superior performance under subsequent harsh charging/discharging conditions encountered over the useful life of the battery. Preconditioning may be performed during battery cell manufacturing and assembly during cell formation, or after battery manufacturing and assembly but prior to placing the battery in normal service.

Various configurations may include a system comprising an electrified vehicle traction battery having a plurality of cells and configured to power an electric machine that provides propulsive force to an electrified vehicle, and a controller programmed to charge the traction battery at a temperature within a predetermined temperature range, discharge the traction battery at a temperature within the predetermined temperature range, and repeatedly charge/discharge cycle the traction battery at a temperature within the predetermined temperature range a predetermined number of times within a predetermined time period, wherein the predetermined temperature range has a lower threshold of forty degrees Celsius. The controller may perform the charge/discharge cycling before permitting charging of the traction battery at a rate above 1C, where C corresponds to a charging current that charges the traction battery from 0% state of charge (SOC) to 100% SOC in one hour, and before permitting charging of the traction battery at a temperature below ten degrees Celsius, and/or before permitting discharging of the traction battery at a rate above 0.5C at a temperature below ten degrees Celsius. In one or more configurations, the controller performs the charge/discharge cycling before permitting charging/discharging of the battery below −10 degrees Celsius. In various configurations, the predetermined number of times is between 5 and 10, inclusive, and/or the predetermined temperature range has an upper threshold of fifty degrees Celsius.

Embodiments of the disclosure may include a method for preconditioning a battery cell, comprising, before charging the battery cell at a rate above 1C, where C corresponds to a charging current that charges the battery cell from 0% state of charge (SOC) to 100% SOC in one hour, and before charging the battery cell at a temperature below 10 degrees Celsius, charging the battery cell at a temperature within a predetermined temperature range, discharging the battery cell at a temperature within the predetermined temperature range, and repeating the charging and discharging at a temperature within the predetermined temperature range a predetermined number of times, wherein the predetermined temperature range has a lower threshold of forty degrees Celsius. The predetermined temperature range may have an upper threshold of fifty degrees Celsius. The predetermined number of times may be five or more. In one or more embodiments, the predetermined number of times does not exceed ten. Embodiments may also include a predetermined number of times between five and ten, inclusive. Alternatively, preconditioning may be performed during battery cell manufacturing by elevating the temperature to a range of 40-50° C. during formation. The battery cell may be configured as one of a plurality of electrically connected battery cells of a multi-cell battery, such as an electrified vehicle traction battery, for example. The method may be performed after the plurality of cells are electrically connected to one or more other cells.

In one or more embodiments, an electrified vehicle battery includes a plurality of electrically connected battery cells disposed within a container, the battery cells being preconditioned by a one-time process of being subjected to a predetermined number of charge/discharge cycles at a temperature above 40° C. The one-time process may be performed prior to the battery cells being electrically connected. Alternatively, preconditioning may be performed during cell manufacturing by elevating the temperature to a range of 40-50° C. during cell formation. In various embodiments, the one-time process is performed at any time before charging the battery at a temperature below 10° C. In one embodiment, the one-time process may be performed at any time before charging the battery at a rate exceeding 1C, where C corresponds to a charging current that charges the battery from 0% state-of charge (SOC) to 100% SOC in one hour. In one embodiment, the one-time process is performed before discharging the battery at a rate exceeding 0.5C, where C corresponds to a discharge current that discharges the battery from 100% state-of-charge (SOC) to 0% SOC in one hour. In various embodiments, the predetermined number of charge/discharge cycles does not exceed 10 cycles. In at least one embodiment, the predetermined number of charge/discharge cycles ranges from 5 to 10 cycles. In one or more embodiments, cell formation or the predetermined number of charge/discharge cycles are performed within a temperature range of 40° C.-50° C. In various embodiments, the charge/discharge cycles are performed continuously and sequentially until completed. In one or more embodiments, the predetermined number of charge/discharge cycles are initiated and completed within a predetermined time period.

One or more embodiments according to the disclosure may provide associated advantages. For example, a single one-time preconditioning of an LIB cell before fast charging/discharging or charging/discharging at low temperature may stabilize the cell performance over the life of the cell even when subjected to harsh conditions during normal service after preconditioning. As such, preconditioned cells/batteries according to this disclosure may facilitate fast charging/discharging under lower temperatures than unconditioned cells/batteries.

### BRIEF DESCRIPTION OF THE DRAWINGS

FIG. 1 illustrates operation of a system or method for initial preconditioning of an LIB cell or multi-cell LIB prior to placing in service according to one or more embodiments of the disclosure.

FIG. 2 illustrates operation of a battery cell preconditioned during formation during subsequent low temperature cycling relative to an unconditioned cell/battery.

FIG. 3 illustrates operation of a preconditioned finished cell/battery relative to an unconditioned finished cell/battery during use after the initial, one-time preconditioning.

FIG. 4 is a diagram illustrating an electrified vehicle having a multi-cell traction battery preconditioned according to one or more embodiments of the disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the claimed subject matter. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Lithium-ion batteries (LIBs) have penetrated many aspects of modern-day life powering mobile phones, computers, power tools, electronics, and of course various types of electrified vehicles, such as hybrid electric vehicles, plug-in hybrid electric vehicles, battery electric vehicles, etc. (generally referred to as xEVs). The high energy and long cycle life under typical operating conditions for many applications have enabled LIBs to be the desired choice among various other energy storage technologies. However, under some harsh operating conditions, such as low temperature and/or high charge/discharge rate conditions, the performance of LIBs may be disappointing to some users. While significant research efforts have focused on the battery electrolyte and treatments on active materials and/or electrode microstructures, most commercially available LIBs cannot be cycled under low temperature or fast charging without affecting the life of the cells. As such, various charging/discharging control strategies may limit the charging/discharging rates to maintain battery state of health and desired battery life, which may also affect overall customer satisfaction.

The present inventors have recognized that an initial, one-time preconditioning process for cells/batteries that includes elevating temperature to perform cell formation within a predetermined temperature range, or charge/discharge cycling for a predetermined number of cycles, such as between about 5 and 10 cycles, at a temperature within a predetermined temperature range, such as a temperature between about 40˜50° C. can greatly increase the stability of cells and subsequent charging/discharging performance under harsh conditions. Furthermore, the preconditioning process may be performed either during cell formation, or after finished cells have been assembled into a multi-cell battery. However, it is desirable to perform preconditioning before the cells/battery have been placed in service and subjected to multiple charge/discharge cycles and/or charge/discharge cycles under harsh conditions, such as low temperature and/or high charge/discharge rates.

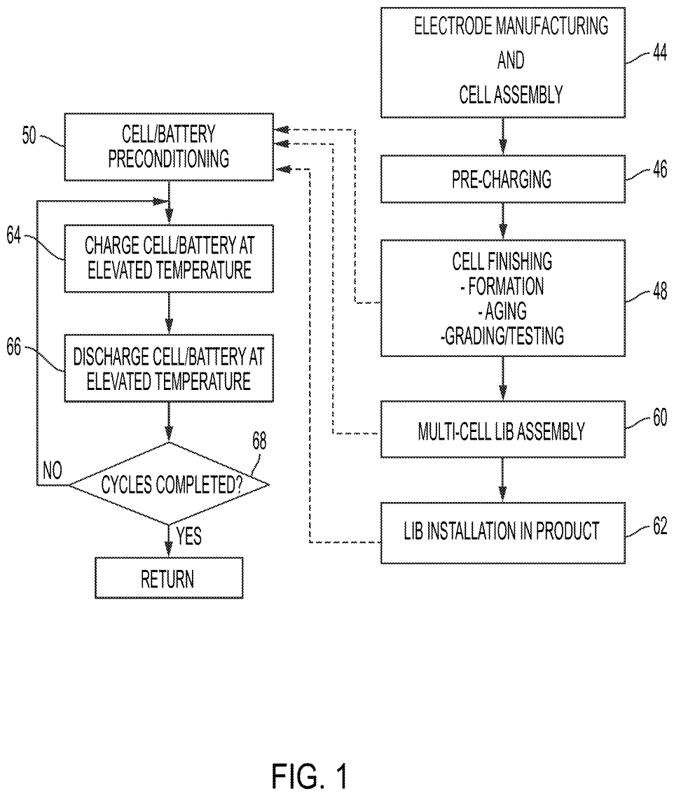

FIG. 1 illustrates operation of a system or method for initial preconditioning of an LIB cell or multi-cell LIB prior to placing in service according to one or more embodiments of the disclosure. As those of ordinary skill in the art will appreciate, the initial preconditioning may be applied to various types of LIB cells including but not limited to solid-state cells. Representative LIB electrode manufacturing and cell assembly is represented at 44. The electrode manufacturing and cell assembly process may vary depending on the particular type of cell. In one non-limiting example, each cell includes a laminar structure or stack having a cathode, separation layer, and anode positioned within a container that is filled with an electrolyte and sealed. Terminals connected to the cathode and anode extend from the container and may be used to electrically connect a plurality of cells together in series and/or parallel to form a multi-cell LIB. In some applications, two or more stacks may be electrically connected together within a single cell. The container may be implemented by a rigid prismatic or cylindrical container, or a flexible package or pouch depending on the particular application.

After assembly, the cell may be pre-charged to about 2V as represented at 46 to inhibit corrosion during the remaining manufacturing process. However, the cell still has a 0% SOC at this point. The sealed LIB cell then proceeds to cell finishing as represented at step 48, which may include cell formation, aging, and grading/testing.

According to one or more embodiments of the present disclosure, cell preconditioning may be performed during formation as represented at 50 by completing formation at an elevated temperature or within a predetermined temperature range above the specified elevated temperature. In various embodiments, the elevated temperature is above 40° C. In one or more embodiments, the elevated temperature range is between about 40° C.-50° C. inclusive. During cell formation, a solid electrolyte interphase (SEI) will form at the electrode, mostly on the anode. Cell formation may include charging/discharging the cell very slowly over a period of time. For example, the cell charging/discharging rate may be limited to 0.1C, where C is the current required for the cell to go from 0% SOC to 100% SOC in one hour while charging, and from 100% SOC to 0% SOC while discharging. As such, a rate of 0.1C would require 10 hours to charge from 0% to 100% SOC, followed by 10 hours to discharge from 100% SOC to 0% SOC. At 100% SOC, the cell may have an open circuit voltage (OCV) of about 3.6V-4.2V compared to an OCV of about 2V at 0% SOC. The charging/discharging cycle may be repeated a number of times, such as 5-10 times at the elevated temperature or within the elevated temperature range to provide preconditioning during formation according to the present disclosure. Alternatively, preconditioning may be provided after cell formation as described in greater detail herein.

Cell grading/testing as represented at 48 may use significantly higher currents, such as 1C for charging and 0.5C for discharging and may include several charge/discharge cycles. Cells may be graded and sorted based on their response so that cells having similar behavior may be subsequently connected in a module with multiple modules connected in a multi-cell battery pack as represented at 60.

According to one or more embodiments of the present disclosure, preconditioning may be performed on a cell module containing multiple cells, or on a battery pack containing multiple cells/modules as represented by blocks 64, 66, and 68. Similar to the preconditioning performed during cell formation, preconditioning performed on a finished cell, cell module, or group of modules connected in a battery pack includes charging of the cell/module/pack at an elevated temperature or within an elevated temperature range as represented at 64, followed by discharging the module/pack at the elevated temperature or within the elevated temperature range as represented at 66. The charge/discharge cycling is repeated for a predetermined number of cycles at the elevated temperature or within the elevated temperature range as represented at 68 to precondition the cell/module/pack/battery. In various embodiments, the predetermined number of cycles are performed continuously in sequence until completed. Embodiments may also include performing the predetermined number of cycles within a predetermined time period. It should be noted the elevated temperature or temperature range for charging may differ somewhat from the elevated temperature or temperature range for discharging within a cycle or among cycles. Similarly, the charging current/rate and discharging current/rate may be different and may vary somewhat within a charge/discharge cycle or among charge/discharge cycles. In one or more embodiments, the elevated temperature is a temperature exceeding 40° C. Embodiments include charge/discharge cycling at a temperature within an elevated temperature range of about 40° C. to about 50° C. Various embodiments include repeating the charge/discharge cycles at least 5 times, and repeating the charge/discharge cycles between 5 and 10 times.

As generally illustrated at block 62 of FIG. 1, an LIB having cells conditioned during formation may be installed in a product. In one embodiment, LIB cells preconditioned during formation and assembled into a battery pack are installed in an electrified vehicle. As also illustrated, preconditioning as represented by blocks 64, 66, and 68 may be performed after installation of a multi-cell battery into a product. Rather than being performed during cell formation, in one embodiment, preconditioning as generally represented by blocks 64, 66, and 68 is performed on a traction battery pack after being installed in an electrified vehicle. Control of the charge/discharge cycling for preconditioning may be performed by a vehicle controller or by an external controller in an assembly plant, for example.

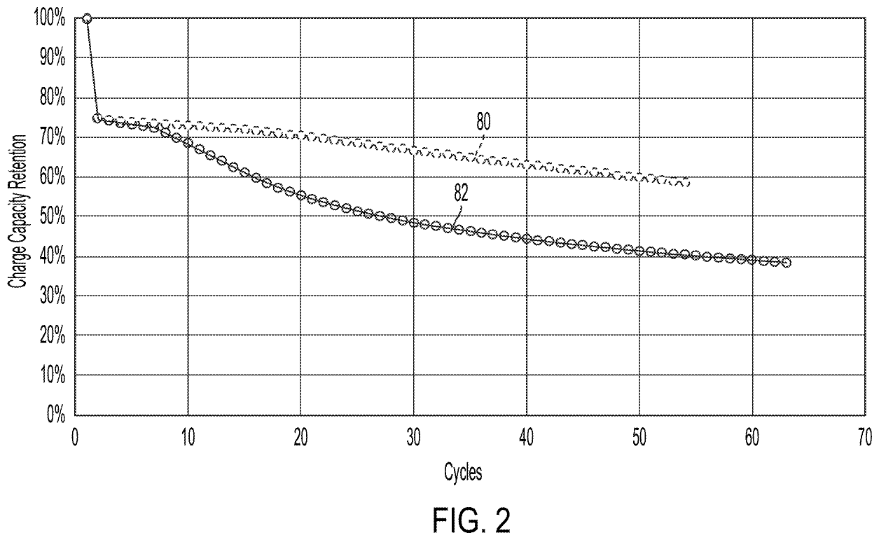

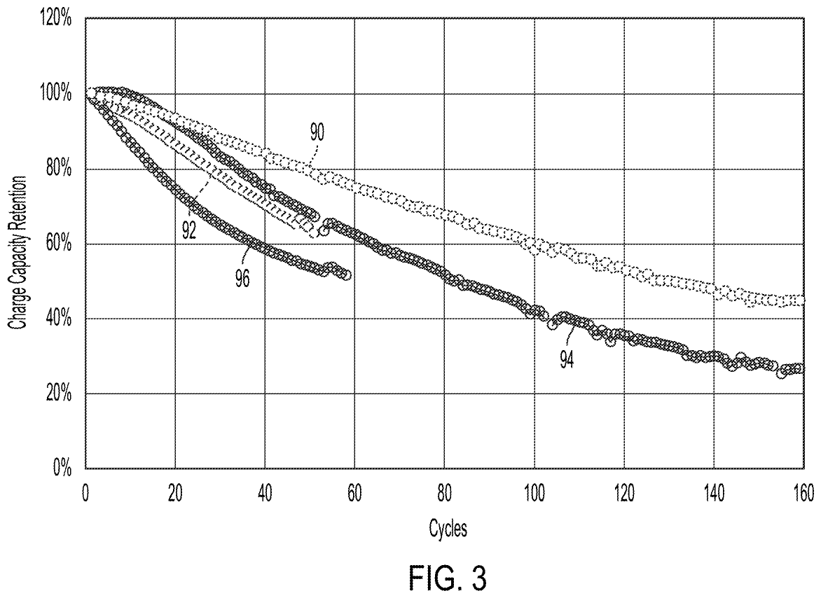

Whether performed during cell formation, or after formation on a cell, cell module, or multi-cell battery either prior to installation in a product, or after installation in a product, the preconditioning is an initial, one-time process that does not need to be repeated before subsequent charge/discharge cycles during normal service operation to provide the better performance under harsh conditions relative to an unconditioned cell/module/pack as illustrated in FIGS. 2-3. For best results, it is desirable to perform the preconditioning before the cell/module/pack is subjected to normal service charge/discharge cycling and/or is subjected to harsh conditions, such as charging/discharging rates above 1C or 1.5C and/or charging/discharging below 10° C.

FIG. 2 illustrates operation of a battery cell/module/pack having the battery cell(s) preconditioned during formation when subjected to subsequent low temperature cycling compared to performance of an unconditioned cell/battery under similar conditions. The diagram of FIG. 2 illustrates charge capacity retention as a function of cycles under representative harsh, low-temperature conditions of −10° C. for charging and discharging at a rate of 0.5C. A battery cell/module/pack having cell(s) preconditioned during formation at an elevated temperature of 45° C. are represented by data points/line 80 as compared to an unconditioned cell/module/pack with cells activated during formation at room temperature of about 23° C. as represented by data points/line 82. As illustrated in FIG. 2, preconditioning according to the present disclosure may increase charge capacity retention from about 40% to about 60% (a 50% increase) after being subjected to 50 charge/discharge cycles.

FIG. 3 illustrates operation of a preconditioned finished cell/module/battery relative to an unconditioned finished cell/module/battery during use after the initial, one-time preconditioning. The diagram of FIG. 3 compares charge capacity retention as a function of cycles under representative harsh, low-temperature conditions of −10° C. for charging/discharging at a rate of 0.5C, as well as fast charge cycling at a charging rate of 1.5C and discharging rate of 0.5C. Battery cells/modules/packs having cell(s) preconditioned according to one or more embodiments of the present disclosure for about 5 charge/discharge cycles at an elevated temperature of about 45° C. are represented by data/lines 90, 92, with data/line 90 illustrating fast charge cycling and data/line 92 illustrating cold temperature cycling. Unconditioned battery cells/modules/packs are represented by data/lines 94, 96, with data/line 94 illustrating fast charge cycling and data/line 96 illustrating cold temperature cycling. As illustrated by data/lines 90, 94 in FIG. 3, preconditioning according to the present disclosure may increase charge capacity retention from about 40% (line 94) to about 60% (line 90—a 50% increase) after being subjected to about 100 fast charge/discharge cycles (1.5C charge rate, 0.5C discharge rate). Likewise, as represented by data/lines 92, 96, preconditioning according to the present disclosure may increase charge capacity retention from about 60% (line 96) to about 70% (line 92—a 17% increase) after being subjected to about 40 charge/discharge cycles at −10° C. (0.5C charge rate, 0.5C discharge rate).

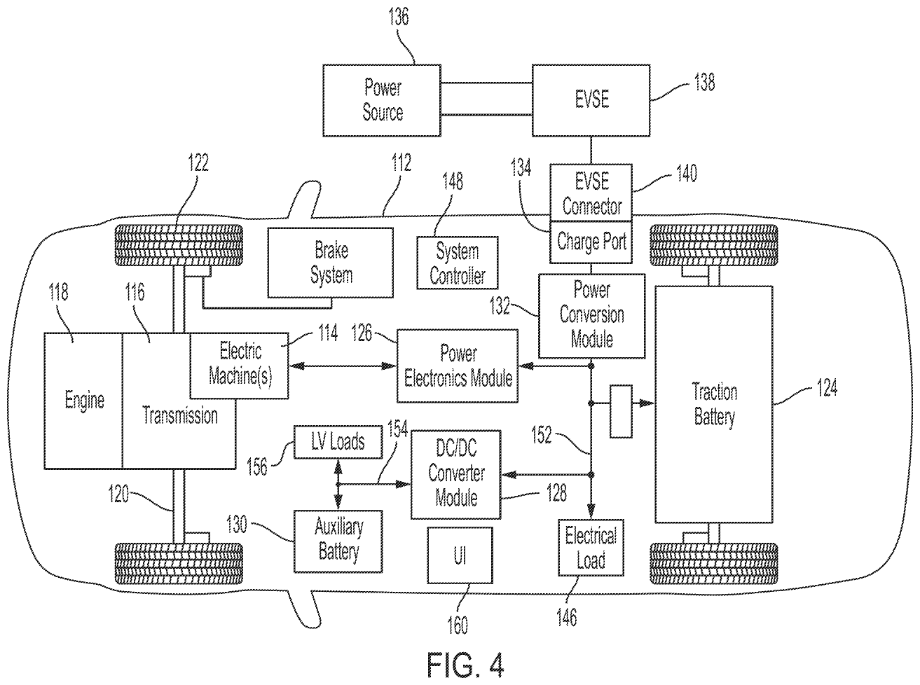

FIG. 4 is a diagram illustrating an electrified vehicle having a multi-cell traction battery preconditioned according to one or more embodiments of the disclosure. Electrified vehicle 112 in this example is a plug-in hybrid-electric vehicle (PHEV) for purposes of illustration and description. As previously described, those of ordinary skill in the art will recognize a wide variety of electrified vehicle and non-vehicle applications that may benefit from cell/module/battery preconditioning according to the present disclosure.

A plug-in hybrid-electric vehicle 112 may include one or more electric machines 114 mechanically coupled to a gearbox or hybrid transmission 116. The electric machines 114 may be capable of operating as a motor and a generator. In addition, the hybrid transmission 116 is mechanically coupled to an engine 118. The hybrid transmission 116 is also mechanically coupled to a drive shaft 120 that is mechanically coupled to one or more of the wheels 122. An electrified vehicle 112 may also be a battery electric vehicle (BEV) without an engine 118 may not be present.

A battery pack or traction battery 124 stores energy that can be used by the electric machines 114. As previously described, traction battery 124 may be assembled using battery cells that were preconditioned during formation. Alternatively, traction battery 124 may be preconditioned prior to installation in electrified vehicle 112, or during installation/assembly with preconditioning controlled by a vehicle controller, such as controller 148, or by an external controller temporarily connected to the battery/vehicle during battery preparation or vehicle assembly. The traction battery 124 may provide a high voltage (HV) direct current (DC) output. As generally understood by those of ordinary skill in the art, high voltage generally refers to voltages above 60 VDC and representative traction battery packs may connect multiple low-voltage cells to operate at a pack voltage in the hundreds of volts, such as 300-800 VDC, for example. Low voltage (LV) systems and components for passenger vehicles may operate at a nominal 12 VDC, while commercial vehicles or transportation vehicles may have LV systems that operate at 24 VDC or 48 VDC, for example.

In addition to providing energy for propulsion, the traction battery 124 may provide energy for other vehicle electrical systems. The electrified vehicle 112 may include a DC/DC converter module 128 that converts the high voltage DC output from the high-voltage bus 152 to a low-voltage DC level of a low-voltage bus 154 that is compatible with low-voltage loads 156. Loads may include one or more fluid pumps that pump a lubricating and/or cooling fluid to the vehicle drivetrain or propulsion system, which may include electric machines 114, transmission 116, engine 118, traction battery 124, DC/DC converter module 128, and power conversion module 132, for example. Other LV loads include various system controllers or control modules that power and/or control vehicle accessories, lights, displays, interfaces, driver inputs, etc.

An output of the DC/DC converter module 128 may be electrically coupled to a low-voltage auxiliary battery 130 (i.e., 12V, 24V, or 48V battery) for charging the auxiliary battery 130. The low-voltage loads 156 may be electrically coupled to the auxiliary battery 130 via the low-voltage bus 154. One or more controllers, such as system controller 148 may be powered by the low-voltage bus 154.

The electrified vehicle 112 may be configured to recharge the traction battery 124 from an external power source 136. The external power source 136 may be a connection to an electrical outlet. The external power source 136 may be electrically coupled to a charge station or electric vehicle supply equipment (EVSE) 138. The external power source 136 may be an electrical power distribution network or grid as provided by an electric utility company. The EVSE 138 may provide circuitry and controls to manage the transfer of energy between the power source 136 and the vehicle 112. The external power source 136 may provide DC or AC electric power to the EVSE 138. The EVSE 138 may have a charge connector 140 for coupling to a charge port 134 of the vehicle 112. The charge port 134 may be any type of port configured to transfer power from the EVSE 138 to the vehicle 112. The charge port 134 may be electrically coupled to an on-board power conversion module or charger 132. The charger 132 may condition the power supplied from the EVSE 138 to provide the proper voltage and current levels to the traction battery 124 and the high-voltage bus 152. Alternatively, various components described as being electrically coupled or connected may transfer power using a wireless inductive coupling.

The electrified vehicle 112 may further include a human-machine interface (HMI) or user interface (UI) 160. The user interface 160 may provide a variety of display elements for communicating information to the operator. The user interface 160 may provide a variety of input elements for receiving information from the operator and may be used to initiate a one-time battery preconditioning using a designated service mode or key during vehicle assembly, for example. The user interface 160 may include one or more displays. The displays may be touch-screen displays that both display information and receive input. The user interface 160 may include discrete lamps/lights. For example, the lamps may include light-emitting diodes (LED). The user interface 160 may include switches, rotary knobs, sliders, and buttons for allowing the operator to change various settings. The user interface 160 may include a control module that communicates via the vehicle network.

While illustrated as a single controller, controller 148 generally represents multiple vehicle controllers that receive signals from associated sensors and control corresponding actuators. Controllers or control modules may be dedicated to a particular vehicle system, subsystem, or component and may include programmable microprocessor-based controllers and microcontrollers that perform various functions and algorithms based on stored program instructions. Various controllers may communicate over one or more channels of the vehicle network(s).

While representative embodiments are described above, it is not intended that these embodiments describe all possible forms encompassed by the claims. The words used in the specification are words of description rather than limitation, and it is understood that various changes can be made without departing from the claimed subject matter. As previously described, the features of various representative embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to strength, durability, life cycle, marketability, appearance, packaging, size, serviceability, weight, manufacturability, ease of assembly, etc. As such, embodiments described as less desirable than other embodiments or prior art implementations with respect to one or more characteristics are not necessarily outside the scope of the disclosure or claimed subject matter and may be desirable for particular applications.

What is claimed is:

1. An electrified vehicle battery comprising:
a plurality of electrically connected battery cells, the battery cells preconditioned by a one-time process of being subjected to an elevated temperature for a predetermined number of charge/discharge cycles at the elevated temperature within a predetermined period of time.

2. The electrified vehicle battery of claim 1 wherein the one-time process is performed during cell formation.

3. The electrified vehicle battery of claim 2 wherein the elevated temperature is above 40° C.

4. The electrified vehicle battery of claim 1 wherein the one-time process is performed before charging the battery at a temperature below 10° C.

5. The electrified vehicle battery of claim 1 wherein the one-time process is performed before charging the battery at a rate exceeding 1C, where C corresponds to a charging current that charges the battery from 0% state-of charge (SOC) to 100% SOC in one hour.

6. The electrified vehicle battery of claim 1 wherein the one-time process is performed before discharging the battery at a rate exceeding 0.5C, where C corresponds to a discharge current that discharges the battery from 100% state-of-charge (SOC) to 0% SOC in one hour.

7. The electrified vehicle battery of claim 1 wherein the predetermined number of charge/discharge cycles does not exceed 10 cycles.

8. The electrified vehicle battery of claim 1 wherein the predetermined number of charge/discharge cycles ranges from 5 to 10 cycles.

9. The electrified vehicle battery of claim 1 wherein the cell formation or the predetermined number of charge/discharge cycles are performed within a temperature range of 40° C.-50° C.

10. A method for preconditioning a battery cell, comprising:
before charging the battery cell at a rate above 1C, where C corresponds to a charging current that charges the battery cell from 0% state of charge (SOC) to 100% SOC in one hour, and before charging the battery cell at a temperature below 10 degrees Celsius:
charging the battery cell at a temperature within a predetermined temperature range;
discharging the battery cell at a temperature within the predetermined temperature range; and
repeating the charging and discharging at a temperature within the predetermined temperature range a predetermined number of times, wherein the predetermined temperature range has a lower threshold of forty degrees Celsius.

11. The method of claim 10 wherein the predetermined temperature range has an upper threshold of fifty degrees Celsius.

12. The method of claim 11 wherein the predetermined number of times is five or more.

13. The method of claim 12 wherein the predetermined number of times does not exceed 10.

14. The method of claim 10 wherein the predetermined number of times is between 5 and 10, inclusive.

15. The method of claim 10 wherein the method is performed during battery cell formation.

16. The method of claim 10 wherein the battery cell comprises one of a plurality of electrically connected battery cells configured as a multi-cell battery.

17. The method of claim 16 wherein the method is performed after the plurality of cells are electrically connected.

18. A system comprising:
an electrified vehicle traction battery having a plurality of cells and configured to power an electric machine that provides propulsive force to an electrified vehicle; and
a controller programmed to:
charge the traction battery at a temperature within a predetermined temperature range;
discharge the traction battery at a temperature within the predetermined temperature range; and
repeatedly charge/discharge cycle the traction battery at a temperature within the predetermined temperature range a predetermined number of times within a predetermined time period, wherein the predetermined temperature range has a lower threshold of forty degrees Celsius.

19. The system of claim 18 wherein the controller performs the charge/discharge cycling before permitting charging of the traction battery at a rate above 1C, where C corresponds to a charging current that charges the traction battery from 0% state of charge (SOC) to 100% SOC in one hour, and before permitting charging of the traction battery at a temperature below ten degrees Celsius.

20. The system of claim 18 wherein the predetermined number of times is between 5 and 10, inclusive, and wherein the predetermined temperature range has an upper threshold of fifty degrees Celsius.
